(19) United States
(12) Patent Application Publication
(10) Pub. No.: US 2016/0294068 A1
(43) Pub. Date: Oct. 6, 2016

(54) Dielectric Resonator Antenna Element

(71) Applicant: Huawei Technologies Canada Co., Ltd., Kanata (CA)

(72) Inventors: Tarek Djerafi, Montreal (CA); Ke Wu, Montreal (CA)

(21) Appl. No.: 14/673,734

(22) Filed: Mar. 30, 2015

(51) Int. Cl. H01Q 19/06; H01Q 15/08; H01Q 1/38; H01Q 21/29

(52) U.S. Cl. CPC H01Q 19/062; H01Q 21/293; H01Q 15/08; H01Q 1/38

(57) ABSTRACT

A dielectric antenna element for emitting or receiving radio frequencies is disclosed. In an embodiment the dielectric antenna element includes a substrate, a microstrip element supported by the substrate, and at one first dielectric superstrate disposed over the substrate and spaced apart from the substrate, wherein the at least one superstrate comprises a permittivity between 2 and 10.

### TECHNICAL FIELD

The present invention relates generally to a dielectric resonator antenna, and, in particular embodiments, to a microstrip antenna comprising a superstrate.

### BACKGROUND

Microstrip antennas are popular and widely used. They offer attractive features such as low weight, small size, low profile, ease of fabrication, and ease of integration with active components.

### SUMMARY

In accordance with an embodiment of the present invention a dielectric antenna element for emitting or receiving radio frequencies comprises a substrate, a microstrip element supported by the substrate, and at least one first dielectric superstrate disposed over the substrate and spaced apart from the substrate, wherein the at least one superstrate comprises a permittivity between 2 and 10.

In accordance with an embodiment of the present invention a dielectric antenna element for emitting or receiving radio frequencies comprises a substrate, a microstrip element supported by the substrate, and at least one first dielectric superstrate disposed over the substrate and spaced apart from the substrate, wherein the at least one first superstrate comprises a thickness that is substantially a non-zero integer multiple of λ₃/2, and wherein the at least one first superstrate is spaced apart from the substrate by a distance t₂, and wherein the distance t₂ is substantially a non-zero integer multiple of λ₂/2 but not λ₂/4+a non-zero integer multiple of λ₂/2.

In accordance with an embodiment of the present invention a device comprises a dielectric antenna element for emitting or receiving radio frequencies, wherein the dielectric antenna element comprises a substrate, a microstrip element supported by the substrate, and at least one dielectric superstrate disposed over the substrate and spaced apart from the substrate, wherein the at least one superstrate comprises a permittivity between 2 and 10.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1a shows a gain pattern with and without a dielectric superstrate;

FIG. 1b shows a perspective view of a dielectric antenna according to an embodiment;

FIG. 2 shows a cross sectional view of a dielectric antenna element according to an embodiment;

FIG. 3a shows gain variations for dielectric antenna elements with different permittivities;

FIG. 3b shows gain variations for dielectric antenna elements with dielectric superstrates having different thicknesses;

FIG. 3c shows impedance matching for dielectric antenna elements with dielectric superstrates having different thicknesses;

FIG. 3d shows gain variations for different distances between the dielectric superstrate and the board;

FIG. 3e shows front-to-back ratio variation for different distances between the dielectric superstrate and the board;

FIG. 3f shows cross polarization level variations for different distances between the dielectric superstrate and the board;

FIG. 4a shows a cross sectional view of a dielectric antenna element according to another embodiment; and

FIG. 4b shows a gain of two lenses (dielectric superstrates) relative to one lens (dielectric superstrate).

### DETAILED DESCRIPTION OF ILLUSTRATIVE EMBODIMENTS

One of the major disadvantages usually associated with printed antennas is low gain. The gain of a typical Hertzian dipole on a grounded substrate is about 6 dB. Even though printed antennas have recently been improved by adding a superstrate they still lack high gain over a broad bandwidth. The improved antennas include a superstrate with ε>>1 (typically ε=10 and higher) and/or μ>>1 (typically μ=10 and higher) over a substrate. The gain varies proportionally to either ε or μ. However, the gain varies inversely with the bandwidth and for practical antenna operation reasons a gain limit needs to be established for a reasonable broad bandwidth.

Prior art documents teach that the distance between the superstrate and the substrate should be a quarter wavelength and the distance between the ground and the superstrate should be half a wavelength in order to provide resonance conditions for a high gain. The relation between the two distances, however, is complex.

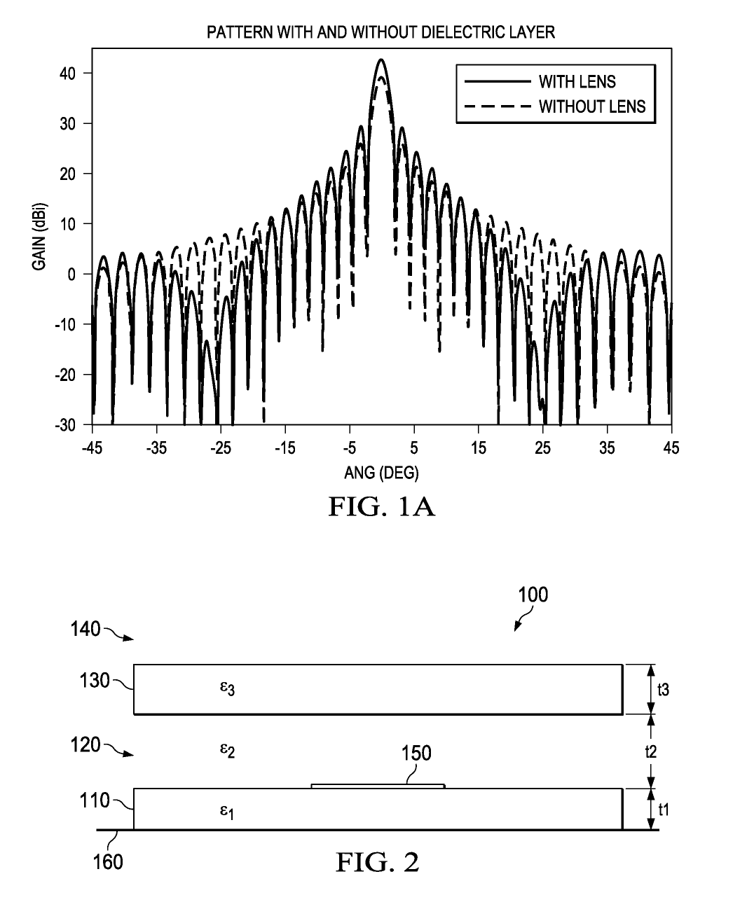

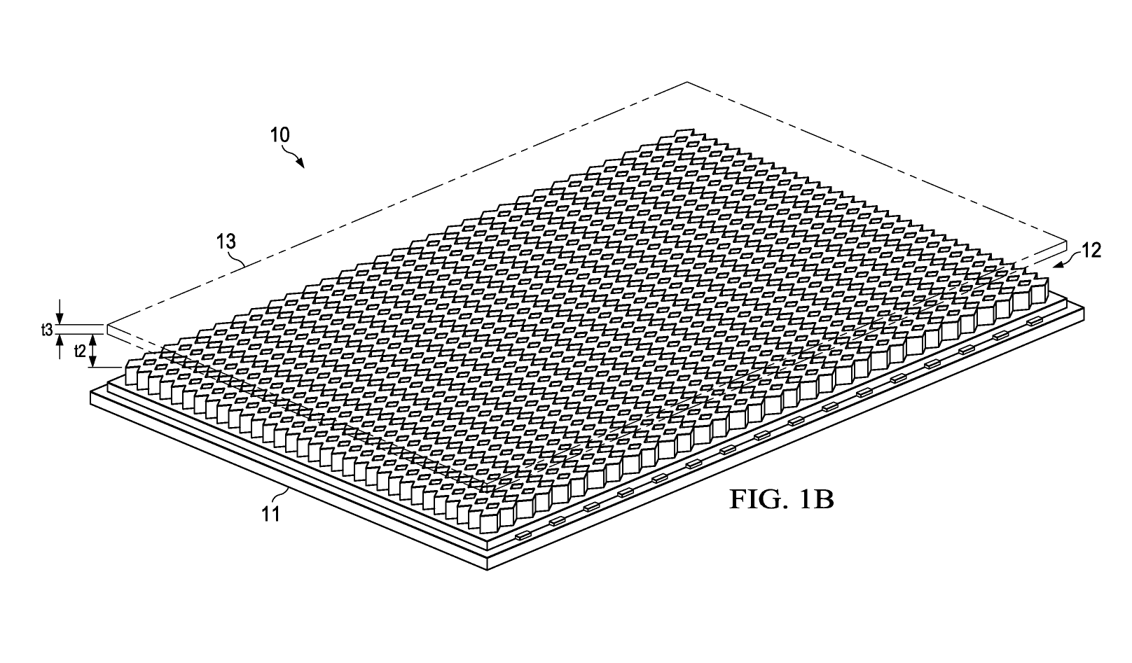

Embodiments of the present application provide improved resonance gain over a wide bandwidth. Further embodiments provide a dielectric superstrate (or dielectric layer) disposed or stacked over a microstrip element, wherein the dielectric superstrate has a permittivity of less than 10. The dielectric superstrate is part of the antenna. Different thicknesses and permittivities of the dielectric superstrate have significant effects on antenna efficiency and gain. Other embodiments provide antenna efficiency and gain improvements by stacking the dielectric superstrate at a selected distance from the microstrip element supported by the substrate. FIG. 1a shows improvements of a dielectric antenna element over conventional antenna elements.

An advantage for these arrangements may be that the gain of the antenna can be increased without increasing the size and the footprint of a planar structure and therefore the board. The dielectric superstrate may act as a lens concentrating the emitted radio frequency and increasing the gain.

FIG. 1b shows a perspective view of an antenna array 10 with dielectric antennas according to an embodiment. The array 10 may comprise 32×32 dielectric antenna elements or 16×16 dielectric antenna elements disposed on a board 11. In other embodiments the array of dielectric antennas 10 may comprises other arrangements. The dielectric antenna elements may be dielectric microstrip antennas.

A spacer layer of air or foam 12 is located between the board 11 and superstrate plate or dielectric slab 13. The dielectric superstrate 13 may be fixed or attached to the board 11 via support structures (not shown). In other embodiments, when foam is disposed between the board 11 and the dielectric superstrate plate 13 the spacer layer 12 may not comprise support structures. FIG. 1b shows the thickness t₂ as the thickness for the spacer layer 12 and the thickness t₃ as the thickness of the dielectric superstrate plate 13. The thickness of the dielectric plate 13 t₃ may be proportional to λ_{g}/2 and the thickness t₂ of the spacer layer 12 may be proportional to λ₀/2. In some embodiments the dielectric layer 13 comprises a permittivity ε₃ between 2 and 10, between 2 and 8, or between 2 and 5. In other embodiments the dielectric layer 13 comprises a permittivity ε₃ between 2 and 3.

The dielectric superstrate 13 may be connected to the board 11 via spacer layer 12 comprising insulating supporters such as plastic supporters. The plastic supporters may be nylon screws comprising adjustment members such as nylon nuts to adjust the superstrate 13 relative to the board 11. The dielectric superstrate 13 may be connected to the board 11 via pins or other spacers. The pins or spacers may be fixed to the dielectric superstrate 13 and the board 11 by an adhesive material such as an adhesive paste or adhesive tape. Alternatively, the dielectric superstrate 13 may include the integral insulating supporters such as spacers made from the same material and/or the same process as the dielectric superstrate 13.

The insulating supporters may be arranged around the edge of the antenna array 10 or on the corners of the antenna array 10. In alternative embodiments, the insulating supporters may be arranged in the array 10 (e.g., between the antenna elements) and/or around the edge of the antenna array 10. In some embodiments, the dielectric superstrate 13 is formed as a housing having a hollow space.

In some embodiments the antenna array 10 is configured to operate with frequencies in the range of 10 GHz to 720 GHz. In other embodiments the antenna array 10 may operate with frequencies in the range of 10 GHz to 80 GHz or alternatively, with frequencies between 50 GHz and 70 GHz. In yet alternative embodiments, the antenna array 10 may operate in the range between 10 GHz and 30 GHz.

An advantage of the antenna array 10 is that it combines high gain with broad pass band performance. Furthermore, the antenna array 10 shows excellent front-to-back ratio levels, optimal cross polarization levels, outstanding impedance matching levels and other impressive performance levels. As a result the gain is much higher over a broader band of frequencies compared to conventional arrangements of dielectric antennas.

FIG. 2 shows a cross sectional view of a single dielectric antenna element 100 of the antenna array 10. As can be seen from FIG. 1 the dielectric antenna element can be described as a layer arrangement with four layers (layers 1-4). The layers are arranged on top of each other. Layer 1 comprises a substrate or board 110, layer 2 comprises a spacer layer 120 comprising air or foam, layer 3 comprises a dielectric superstrate 130 and layer 4 comprises free air 140. An antenna element 150 is disposed on, embedded in or supported by the substrate 110.

By using an antenna element 150 supported by a substrate 110 and a dielectric superstrate 130 with an appropriate permittivity ε₃ (e.g., ε₃ between 2 and 3) and changing the distance t₂ between them, resonance condition can be satisfied and a high gain can be obtained. The value of the resonant gain is a function of the thickness t₃ of the superstrate 130 and the thickness t₂ of the spacer layer (or the distance between the board 110 and the superstrate 130). Some embodiments of the invention may show that the optimal distance t₂ is about λ₀/2 and the optimal distance t₃ is about λ_{g}/2).

The substrate 110 may be a circuit board or printed circuit board. The board 110 may comprise a dielectric substrate with a permittivity of ε₁. The board 110 may include a ground plane 160 located on the back side of the board 110 while the antenna element 150 is located on the front side of the board 110. Alternatively, the ground plane 160 may be located within the board 110 or laterally adjacent to the antenna element 150. The ground plane 160 comprises a conductive material such as a metal (e.g., aluminum, copper, or alloys thereof). The board 110 has a thickness of t₁ without the ground plane 160. In some embodiments the thickness t₁ may be 0.2 mm to 5 mm, more particularly, 0.2 mm to 2 mm, alternatively 0.5 mm.

The antenna element 150 may be a planar antenna element or a quasi-planar antenna element. The antenna element 150 may be a microstrip. The microstrip can be a rectangular patch, a ring patch or an elliptical patch. The antenna element 150 can be a dipole such as a Yagi antenna or an aperture antenna. The antenna element 150 may be embedded in the board 110 or disposed on the board 110. The antenna element may comprise a thickness of 1 μm-50 μm or 15 μm-30 μm.

The spacer layer 120 comprising air, foam or a combination of air and foam, separates the board 110 from the dielectric superstrate 130. The spacer layer 120 comprising air has a permittivity ε₂ of about 1 and the spacer layer 120 comprising foam has a permittivity of ε₂ close to 1, e.g., between 1 and 1.6.

| | |
|---|---|
| Foam polyethylene (RG-58/U) | 1.30 |
| Foam polyethylene (RG-58/AU) | 1.37 |
| Foam polyethylene (RG-8/U) | 1.16 |
| Foam polyethylene (RG-59/U) | 1.20 |
| Foam polyethylene (RG-11/U) | 1.20 |
| Polyethylene (RG-174/U) | 1.52 |

The spacer layer 120 may have a thickness t₂. For optimal gain the thickness t₂ may be selected for a selected frequency or a frequency range according to the equation provided below. In some embodiments the thickness t₂ of the spacer layer 120 may be between 1 mm and 10 mm.

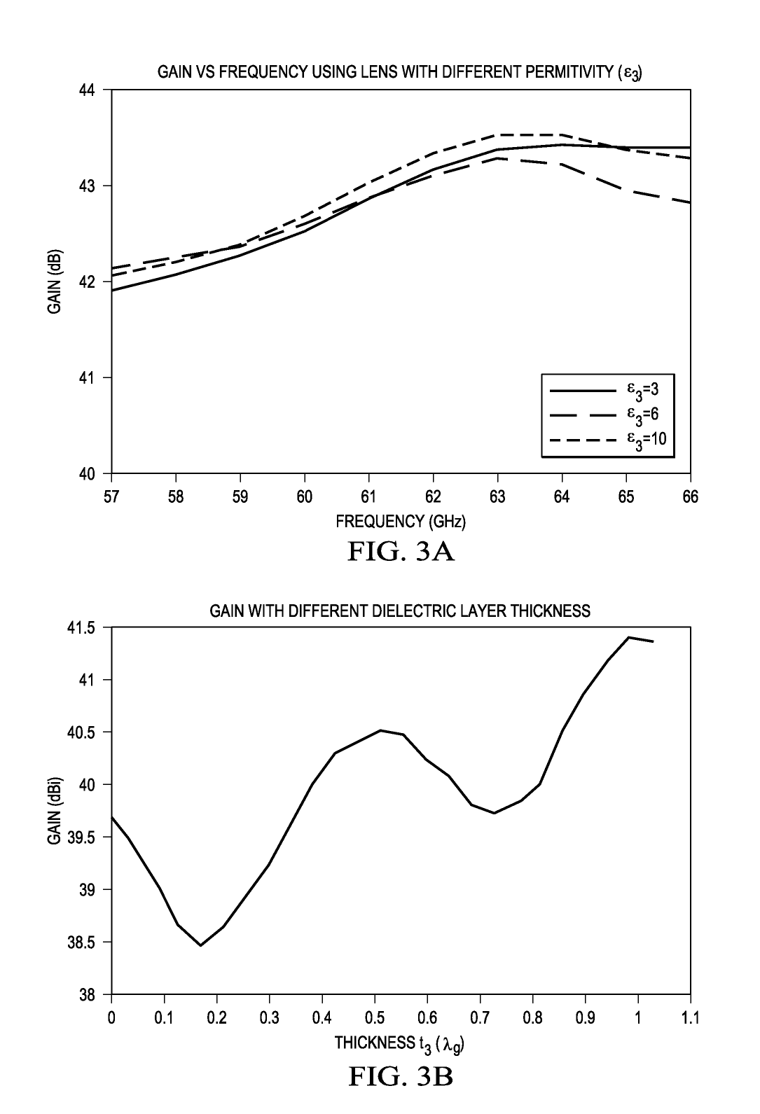

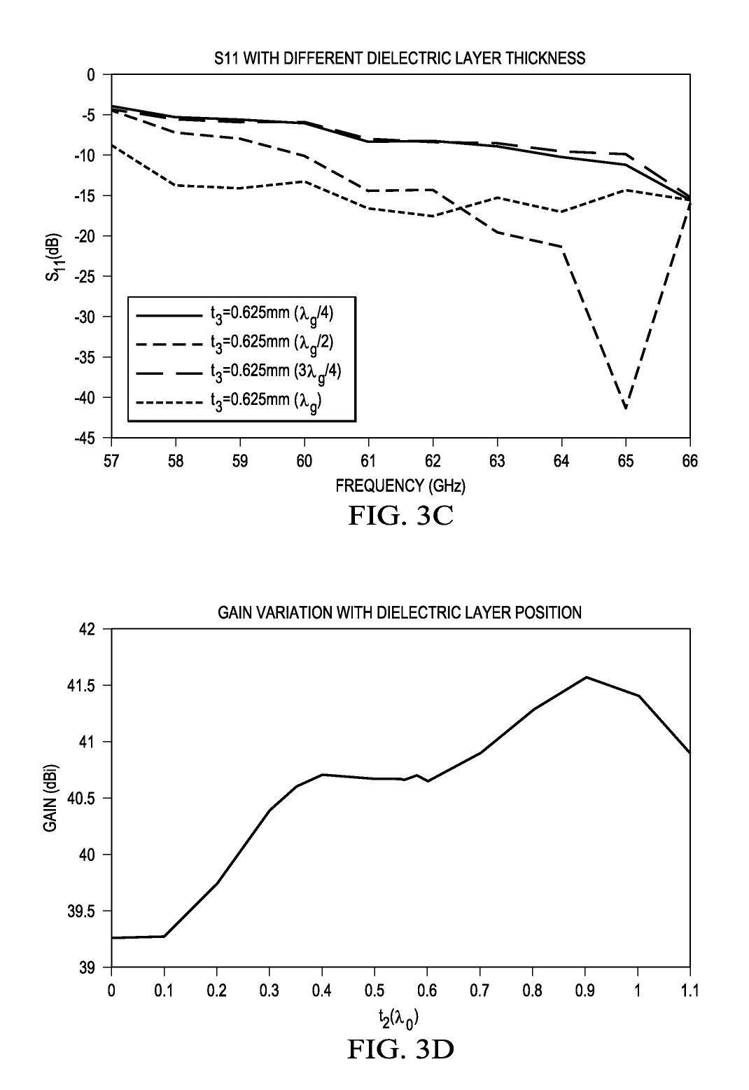

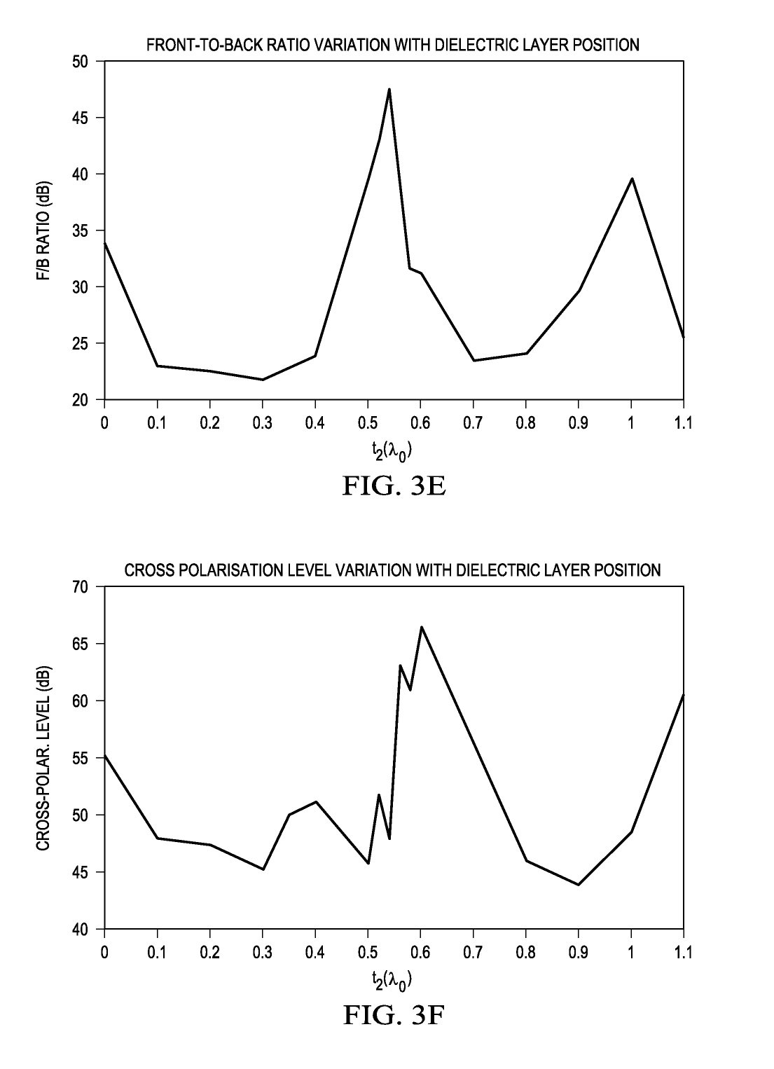

The dielectric superstrate 130 comprises a dielectric material. Depending on the design and application of the antenna element the dielectric material can be selected having different permittivities ε₃. The permittivity ε₃ may be about 3 (e.g., ε₃=2.9) or between 2 and 3. In some embodiments the permittivity ε₃ is between 2 and 10, between 2 and 8, or alternatively, between 2 and 5. Even though the gains for different permittivities ε₃ of the dielectric superstrate 130 are similar, the lower permittivities promise higher gains than the higher permittivities as can be gathered from FIG. 3a. This is in contrast to conventional wisdom which typically requires permittivities ε₃ of 10 and more.

The dielectric superstrate 130 may an insulating material. The insulating material may be Teflon, ceramic, silicon, nylon, glass, quartz or a combination of these materials. In an embodiment the insulating material may be RT/Duroid® 6002 from Rogers Corporation.

In some embodiment the dielectric superstrate 130 comprises a plurality of dielectric layers. The plurality of dielectric layers may comprise layers with the same permittivity or layers with different permittivities. In one embodiment the layer with the higher permittivity faces the board 110 and in another embodiment the layer with the higher permittivity faces away from the board.

Moreover, the dielectric superstrate 130 may comprise a thickness t₃. FIG. 3b shows the effect of the thickness t₃ on the gain. The gain may increase with the thickness t₃. A resonance condition and therefor a high gain may be achieved when the thickness t₃ of the dielectric superstrate 130 is set to a non-zero integer multiple of half a wavelength λ_{g} (λ_{g} being the wavelength in the superstrate 130). The thickness t₃ may be selected according to the following equation:

$${t}_{3} = n \frac{{λ}_{g}}{2} \qquad ( 1 )$$

wherein n is a non-zero integer number. FIG. 3b illustrates that the gain is higher when n=2 compared to n=1.

FIG. 3c shows impedance matching at a power port S11 for different thicknesses t₃ of the dielectric superstrate 130. As can be seen the dielectric superstrate 130 has less than about 20% reflection (−10 dB) over a wide bandwidth (e.g., 60 GHz-66 GHz) when the thickness t₃ is about non-zero integer multiple of λ_{g}/2. In some embodiments the performance of the dielectric antenna element may be inferior when the thickness t₃ of the superstrate 130 is an odd integer multiple of λ_{g}/4. Accordingly, in some embodiments, the thicknesses t₃ having a thickness of λ_{g}/4, 3λ_{g}/4 or 5λ_{g}/4 etc. are not recommended.

Accordingly, a high gain over a broad bandwidth can be achieved when the thickness t₃ of the dielectric superstrate 130 is set to:

$${t}_{3} = \frac{{λ}_{g}}{2} \qquad ( 2 )$$

For an optimal gain over a wide bandwidth the dielectric superstrate thickness t₃ may be set to n=1 and therefore substantially λ_{g}/2. Substantially λ_{g}/2 means +/−5% or less of λ_{g}/2 and substantially a non-zero integer multiple of λ_{g}/2 means +/−5% or less of the non-zero integer multiple of λ_{g}/2. In some embodiments the dielectric superstrate thickness t₃ may be 1 mm to 10 mm, or more particularly, 1 mm to 2 mm, alternatively 1.5 mm.

For an excellent gain, another resonance condition may be fulfilled by setting the distance t₂ to an adequate position. The position of the dielectric superstrate 130 relative to the board 110 may be set according to the following equation:

$${t}_{2} = n \frac{{λ}_{2}}{2} .$$

In this equation λ₂ is the wavelength (free space λ₀ if air is used) in the spacer layer and n is an integer number. FIG. 2d shows that the forward gain increases when the dielectric superstrate 130 is set at this position with a local maximums of n=1, 2, 3, etc. The cross polarization level may be optimized for thicknesses around t₂ being proportional of λ₂/2 and the front-to-back ratio may be optimized for thicknesses of t₂ proportional to λ₂/2. This is shown in FIGS. 3e and 3f. In some embodiments the front to back ratio may be defined as the difference in gain between the maximum forward gain bearing and another bearing 180 degrees opposite. The forward gain bearing is considered to be orthogonal to the superstrate layer 130 leading away from the top surface into layer 4 (air) and the backward gain bearing is considered to be orthogonal to the board 110 leading away from the bottom side of the board. The thickness of the spacer layer t₂ may be substantially λ₂. Substantially λ₂/2 means +/−5% or less of λ₂/2.

The thickness t₂ may therefore be optimized for λ₂/2 and not for λ₂/4 as suggested for conventional antenna devices. In some embodiments, the thicknesses t₂ is substantially a non-zero integer multiple of λ₂/2 but not λ₂/4+a non-zero integer multiple of λ₂/2, e.g., proportional to λ₂/4, 3λ₂/4 or 5λ₂/4 etc. In some embodiments, the thickness t₃ of the dielectric superstrate for a frequency band may be selected such that wavelength in the superstrate 130 λ_{g} is the middle wavelength of the frequency band and/or the thickness t₂ of the spacer layer 120 may be selected such that the wavelength in the spacer layer λ₂ is the middle wavelength of that band. For example, the thickness t₃ of the superstrate 130 for the frequency band 50 GHz-70 GHz (the middle frequency being 60 GHz) is about 2.9 mm (for a superstrate with a permittivity ε₃ of 2.9) and the thickness t₂ of the spacer 120 layer is about 5 mm. Similarly, the thickness t₃ for the superstrate 130 for the band 71 GHz-76 GHz is about 2.4 mm (with a permittivity ε₃ of 2.9) and the thickness t₂ of the spacer layer 120 is about 4 mm. Moreover, the thickness t₃ of the superstrate for the band 81 GHz-86 GHz is 2 about mm (with a permittivity of ε₃ of 2.9) and the thickness t₂ of the spacer layer 120 is about 3.6 mm. Finally, the thickness t₃ of the superstrate 130 for the band 92 GHz-95 GHz is about 1.9 mm (with a permittivity of ε₃ of 2.9) and the thickness t₂ of the spacer layer 120 is about 3.2 mm.

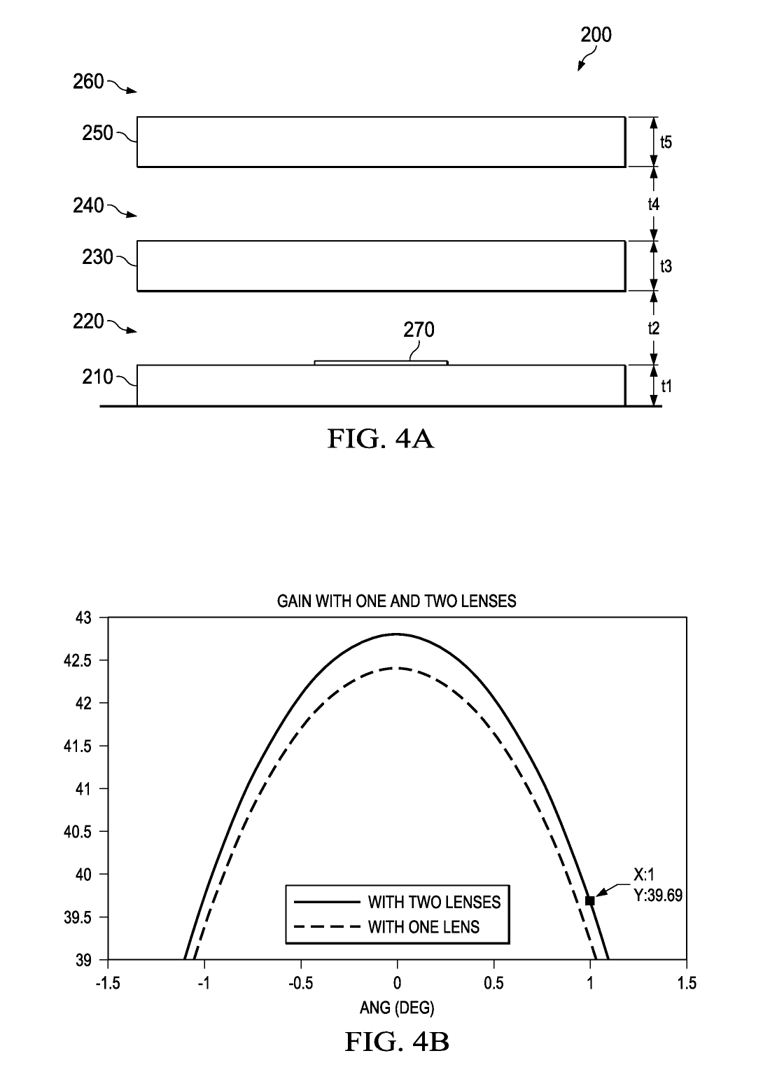

FIG. 4a shows a further embodiment of the dielectric antenna element 200. Instead of having one lens the dielectric antenna element 200 in this embodiment has two lenses.

FIG. 4a shows a cross sectional view of a single dielectric antenna element 200 of the antenna array 10. As can be seen from FIG. 4a the dielectric antenna element can be described as a layer arrangement with six layers (layers 1-6). The layers are arranged on top of each other. Layer 1 comprises a substrate or board 210, layer 2 comprises a first spacer layer 220 comprising air or foam, layer 3 comprises a first dielectric superstrate 230, layer 4 comprises a second spacer layer 240 comprising air or foam, layer 5 comprises a second dielectric superstrate 250 and layer 6 comprises free air 260. An antenna element 270 is disposed on, embedded in or supported by the substrate 210. The first four layers may have the same properties and characteristics as the four layers of FIG. 2. The materials and the permittivities of the first and second dielectric superstrates 230, 250 may be the same or may be different. The thicknesses t₃ and t₅ of the dielectric superstrates 230, 250 may be the same or may be different. The distances t₂ and t₄ of the spacer layers 220, 240 may be the same or may be different. Since in some embodiments the permittivities ε₃ and ε₅ of the first and second superstrates are different so are the wavelengths λ_{g} (e.g., λ₃ and λ₅) of the passing light in these superstrates different. Similarly, since the permittivities ε₂ and ε₄ of the first and second spacer layers can be different the wavelengths λ₂ and λ₄ of the light passing through the spacer layers can be different. In other embodiments, the permittivities of the superstrates are the same and the permittivities of the spacer layers are the same. In yet other embodiments, the permittivities of the superstrates are different (the same) and the permittivity of the spacer layers are the same (are different).

The antenna element 200 comprising a board 210, a first dielectric superstrate 230 having an appropriate first thickness t₃ and an appropriate first permittivity ε₃ (e.g., ε₃ between 2 to 3), a second dielectric superstrate 250 having an appropriate second thickness t₅ and an appropriate second permittivity ε₅ (e.g., ε₅ between 2 to 3), and appropriate distances t₂ and t₄ of the first and second spacer layers 220, 240 can satisfy a high gain over a broad bandwidth. The value of the resonant gain and the width of the pass band are a function of the thicknesses t₃ and t₅ of the superstrates 230, 250 and the thickness t₂ and t₄ of the spacer layers 220, 240.

An advantage of such an arrangement is that the gain of a dielectric antenna with two lenses may be even higher than the gain of a dielectric antenna with a single lens. Moreover, a further advantage is that the 3 dB beamwidth of the radiation pattern may be even smaller. This can be seen in FIG. 4b.

Embodiments of the invention may provide dielectric antennas with three or more dielectric superstrates.

Embodiment of the invention may be applied to automotive applications such as automotive radar or telecommunication applications such as transceiver applications in base stations or user equipment (e.g., hand held devices).

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A dielectric antenna element for emitting or receiving radio frequencies comprising:
a substrate;
a microstrip element supported by the substrate; and
at least one first dielectric superstrate disposed over the substrate and spaced apart from the substrate, wherein the at least one first superstrate comprises a permittivity between 2 and 10.

2. The dielectric antenna element according to claim 1, wherein the at least one first superstrate comprises a permittivity between 2 and 5.

3. The dielectric antenna element according to claim 1, wherein the at least one first superstrate comprises a permittivity between 2 and 3.

4. The dielectric antenna element according to claim 1, further comprising at least one second dielectric superstrate disposed on and spaced apart from the at least one first dielectric superstrate, the permittivity of the at least one second superstrate is between 2 and 10.

5. The dielectric antenna element according to claim 1, wherein the substrate is a printed circuit board.

6. The dielectric antenna element according to claim 1, wherein the at least one first dielectric superstrate comprises a thickness of substantially λ_{g}/2.

7. The dielectric antenna element according to claim 1, wherein the at least one first dielectric superstrate is spaced apart from the substrate by a distance t₂, and wherein the distance t₂ is substantially a non-zero integer multiple of λ₀/2 but not λ₀/4+a non-zero integer multiple of λ₀/2.

8. The dielectric antenna element according to claim 1, wherein the at least one first dielectric superstrates comprises a plurality of dielectric layers.

9. The dielectric antenna element according to claim 1, wherein the microstrip element comprises an array of microstrip elements.

10. The dielectric antenna element according to claim 1, wherein the at least one first superstrate is spaced apart from the substrate by a spacer layer, and wherein the spacer layer comprises air or foam.

11. A dielectric antenna element for emitting or receiving radio frequencies comprising:
a substrate;
a microstrip element supported by the substrate; and
at least one first dielectric superstrate disposed over the substrate and spaced apart from the substrate, wherein the at least one first superstrate comprises a first thickness t₃ that is substantially a non-zero integer multiple of λ₃/2, wherein the at least one first superstrate is spaced apart from the substrate by a first distance t₂, and wherein the distance t₂ is substantially a non-zero integer multiple of λ₂/2 but not λ₂/4+a non-zero integer multiple of λ₂/2.

12. The dielectric antenna element according to claim 11, wherein the at least one first superstrate comprises a permittivity between 2 and 5.

13. The dielectric antenna element according to claim 11, wherein the at least one first superstrate comprises a permittivity between 2 and 3.

14. The dielectric antenna element according to claim 11, further comprising at least one second dielectric superstrate disposed on and spaced apart from the at least one first dielectric superstrate, wherein the at least one second superstrate comprises a second thickness that is substantially a non-zero integer multiple of λ₅/2, and wherein the at least one second superstrate is spaced apart from the at least one first superstrate by a distance t₂₂, and wherein the distance t₂ is substantially a non-zero integer multiple of λ₄/2 but not λ₄/4+a non-zero integer multiple of λ₄/2.

15. The dielectric antenna element according to claim 11, wherein t₃ is substantially λ₃/2 and t₂ is substantially λ₀/2.

16. The dielectric antenna element according to claim 11, wherein the microstrip element comprises an array of microstrip elements.

17. The dielectric antenna element according to claim 11, wherein the at least one first superstrate is spaced apart from the substrate by a spacer layer, and wherein the spacer layer comprises air or a foam.

18. A device comprising:
a dielectric antenna element for emitting or receiving radio frequencies, wherein the dielectric antenna element comprises:
a substrate;
a microstrip element supported by the substrate; and
at least one dielectric superstrate disposed over the substrate and spaced apart from the substrate, wherein the at least one superstrate comprises a permittivity between 2 and 10.

19. The device according to claim 18, wherein the device is a base station.

20. The device according to claim 18, wherein the device is a user equipment.

21. The device according to claim 18, wherein the device is an automotive radar.
